(19) United States
(12) Patent Application Publication
(10) Pub. No.: US 2014/0338637 A1
(43) Pub. Date: Nov. 20, 2014

(54) COMMON RAIL SYSTEM HAVING MECHANICAL UNIT PUMPS

(71) Applicant: Caterpillar Inc., Peoria, IL (US)

(72) Inventors: Scott Shafer, Morton, IL (US); Steven Tian, Bloomington, IL (US)

(73) Assignee: Caterpillar Inc., Peoria, IL (US)

(21) Appl. No.: 13/894,792

(22) Filed: May 15, 2013

(51) Int. Cl. F02M 37/04; F02M 59/48; F02D 1/10

(52) U.S. Cl. CPC F02M 37/043; F02D 1/10; F02M 59/48
USPC 123/445; 29/888.011

(57) ABSTRACT

A fuel system for an engine is disclosed. The engine may have a crankshaft and a plurality of cylinders. The fuel system may have a plurality of plungers separately connectable to the crankshaft and a plurality of fuel injectors associated with the plurality of cylinders. The fuel system may also have a common rail configured to store pressurized fuel. The fuel system may additionally have a plurality of first conduits, each first conduit fluidly connecting a barrel associated with a respective one of the plurality of plungers to the common rail. The fuel system may also have a plurality of second conduits, each second conduit fluidly connecting the common rail to a respective one of the plurality of fuel injectors.

### TECHNICAL FIELD

The present disclosure is directed to a fuel system and, more particularly, to a common rail fuel system for an engine having mechanical unit pumps.

### BACKGROUND

Mechanical unit pumps are driven by an engine crankshaft to transfer fuel from a fuel reservoir to different engine cylinders. In some instances, each engine cylinder is associated with a separate mechanical unit pump. In this arrangement, each mechanical unit pump is connected to a single mechanical nozzle in fluid communication with a respective one of the engine cylinders. Fuel delivered to each mechanical nozzle is directly injected into the associated engine cylinder in response to a pumping stroke of the corresponding mechanical unit pump.

These mechanically controlled fuel systems have drawbacks. For example, since each mechanical injector is individually connected to only one mechanical unit pump, the fuel system will be unreliable if a pump or injector fails. For example, if a pump fails, the corresponding injector and engine cylinder will not receive fuel. If an injector fails, the associated fuel pump will continue to supply fuel that may not be injected into the cylinder, increasing the fuel pressure to a level that could cause additional damage to the engine and fuel system. Similarly, since the timing and pressure of each fuel injection into the different cylinders is controlled by a different mechanical unit pump, the fuel system may be inconsistent across the cylinders. For these reasons it is also difficult to satisfy changing fuel requirements as engine performance conditions change.

An alternative fuel system is disclosed in U.S. Pat. No. 7,950,371, that issued to Cinpinski et al. on May 31, 2011 (“the '371 patent”). In particular, the '371 patent discloses a fuel system having a high-pressure pump that delivers fuel to a fuel rail. The fuel rail is connected between the high-pressure pump and a plurality of fuel injectors. In addition, the fuel system includes an electronic control module (ECM) that electronically controls the high-pressure pump and the fuel injectors. A pressure sensor is included as part of a compensation module to calibrate the high-pressure pump.

While the fuel system of the '371 patent may provide some advantages over mechanically controlled fuel systems, it may be less than optimal. In particular, the fuel system of the '371 patent requires a separate high-pressure pump to supply fuel to the rail. This may be less than optimal for a retrofit application, in which mechanical unit pumps are already in place on the engine. In addition, while the fuel system of the '371 patent utilizes a compensation module to calibrate the high-pressure pump, it may not be compatible with mechanical unit pumps of an existing engine.

The present disclosure is directed to overcoming one or more of the problems set forth above and/or other problems of the prior art.

### SUMMARY

In one aspect, the present disclosure is directed to a fuel system for an engine having a crankshaft and a plurality of cylinders. The fuel system may include a plurality of plungers separately connectable to the crankshaft and a plurality of fuel injectors associated with the plurality of cylinders. The fuel system may also include a common rail configured to store pressurized fuel. The fuel system may additionally include a plurality of first conduits, each first conduit fluidly connecting a barrel associated with a respective one of the plurality of plungers to the common rail. The fuel system may also include a plurality of second conduits, each second conduit fluidly connecting the common rail to a respective one of the plurality of fuel injectors.

In another aspect, the present disclosure is directed to a method of retrofitting an existing engine having a plurality of mechanical fuel pumps and a plurality of cylinders. The method may include fluidly disconnecting each of the mechanical unit pumps from an existing passive mechanical injector. The method may also include fluidly connecting an output of each of the plurality of mechanical unit pumps together by a common rail. The method may additionally include installing a plurality of electronically controlled fuel injectors. The method may also include fluidly connecting the common rail to each of the plurality of electronically controlled fuel injectors.

### BRIEF DESCRIPTION OF THE DRAWINGS

FIG. 1 depicts an exemplary disclosed engine system; and

FIG. 2 depicts an exemplary disclosed mechanical unit pump that may be used in conjunction with the engine system of FIG. 1.

### DETAILED DESCRIPTION

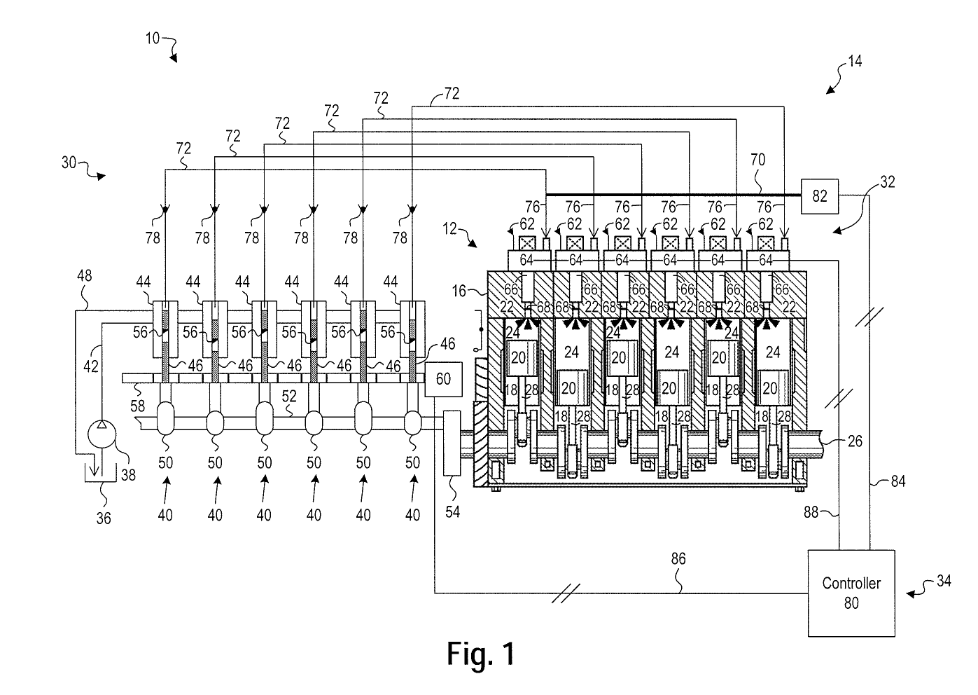

FIG. 1 depicts an exemplary engine system 10 consistent with disclosed embodiments. Engine system 10 may include an internal combustion engine 12 and a fuel system 14. For the purposes of this disclosure, engine 12 is depicted and described as a six-cylinder, diesel engine. One skilled in the art will recognize, however, that engine 12 may be any other type of internal combustion engine such as, for example, a gasoline engine.

Engine 12 may include an engine block 16 that defines a plurality of cylinders 18. A piston 20 may be slidably disposed within each cylinder 18. Engine 12 may also include a cylinder head 22 associated with each cylinder 18. Cylinder 18, piston 20, and cylinder head 22 together may form a combustion chamber 24. In the exemplary embodiment, engine 12 includes six combustion chambers 24. One skilled in the art will readily recognize that engine 12 may include a greater or lesser number of combustion chambers 24 and that combustion chambers 24 may be disposed in an “in-line” configuration, a “V” configuration, or any other conventional configuration.

As also shown in FIG. 1, engine 12 may include a crankshaft 26 rotatably disposed within engine block 16. A connecting rod 28 may connect each piston 20 to crankshaft 26. Each piston 20 may be coupled to crankshaft 26 so that a sliding motion of piston 20 within the respective cylinder 18 results in a rotation of crankshaft 26. Similarly, a rotation of crankshaft 26 results in a sliding motion of piston 20.

Fuel system 14 may introduce fuel into each combustion chamber 24 for subsequent combustion and mechanical output. The timing of fuel injection into combustion chambers 24 may be synchronized with the motion of piston 20. For example, fuel may be injected as piston 20 nears a top-dead-center position in a compression stroke to allow for compression-ignited-combustion of the injected fuel. Alternatively, combustion may be spark-ignited.

Fuel system 14 may include a pumping system 30, an injection system 32, and a control system 34 configured to work in conjunction to supply fuel to engine 12. Pumping system 30 may supply fuel to injection system 32 for injection into combustion chambers 24. Control system 34 may electronically regulate some components of pumping system 30 and injection system 32, as is described in more detail below.

Pumping system 30 may include a fuel reservoir 36, a transfer pump 38, and a plurality of mechanical unit pumps 40 for supplying fuel to injection system 32. Fuel reservoir 36 may be a fuel tank configured to supply fuel to transfer pump 38. Transfer pump 38 may be a low-pressure pump configured to deliver fuel to each mechanical unit pump 40. Transfer pump 38 may be connected to each mechanical unit pump 40 by fuel lines 42. Each mechanical unit pump 40 may be configured to receive fuel from a respective fuel line 42 and pressurize the fuel for delivery to injection system 32.

For the purposes of this disclosure, each mechanical unit pump 40 may take the form of any conventional unit pump that is normally used to deliver fuel to a single engine cylinder. For example, each mechanical unit pump 40 may include a barrel 44 and a plunger 46 that reciprocates within barrel 44 to pressurize fuel in a manner known in the art. After fuel enters barrel 44, plunger 46 may retract into barrel 44 and raise the pressure of the fuel such that a portion of the pressurized fuel may be forced into injection system 32 for subsequent injection into cylinders 18. Any fuel that does not enter injection system 32 may be sent to a low-pressure reservoir, such as fuel reservoir 36, via a spill passage 48. While a unit pump having a barrel 44 and plunger 46 is described herein, it should be understood that mechanical unit pumps 40 may each have another configuration, if desired.

Each plunger 46 may be driven to reciprocate with a cam 50 located on a pump driveshaft 52 that is operatively connected to crankshaft 26. Pump driveshaft 52 may be connected to crankshaft 26 in any manner readily apparent to one skilled in the art where a rotation of crankshaft 26 will result in a corresponding rotation of a pump driveshaft 52. For example, pump driveshaft 52 may be connected to crankshaft 26 through a gear train 54. Rotation of cams 50 may cause linear movement of plungers 46. While cam 50 is disclosed herein, it is contemplated that other driving elements may be utilized to operatively connect rotation between pump driveshaft 52 and plunger 46, such as a swashplate, a wobble plate, a solenoid actuator, a piezoelectric actuator, a hydraulic actuator, a motor, or any other driving means known in the art.

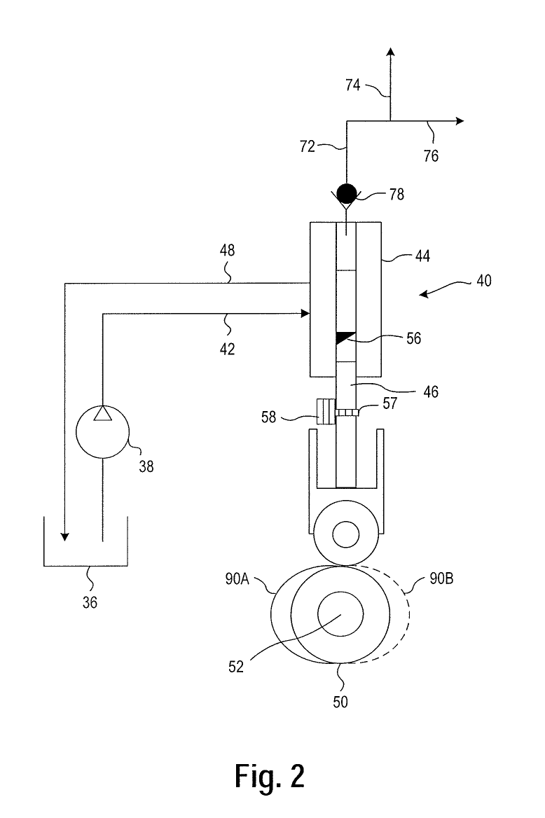

As best seen in FIG. 2, cam 50 may include a lobe 90A configured to force plunger 46 upwardly inside barrel 44. When cam 50 includes only one lobe 90A, plunger 46 may be configured to move through one complete pumping cycle between two spaced apart positions within barrel 44 with each rotation of pump driveshaft 52 (i.e., once per engine cycle). FIG. 2 also depicts an alternative embodiment in which cam 50 includes lobe 90A and a second lobe 90B (shown by dotted lines in FIG. 2). In this embodiment, plunger 46 may be configured to move through two complete cycles between the two spaced apart positions within barrel 44 with each rotation of pump driveshaft 52 (i.e., twice per engine cycle). Therefore, each mechanical unit pump 40 may be configured to pressurize common rail 70 twice per engine cycle. In this way, the number of mechanical unit pumps 40 needed to maintain a desired fuel pressure in common rail 70 may be less than the number of cylinders 18 of engine 12. For example, for an engine 12 in which fuel is injected into each of six cylinders 18 once per engine cycle, pumping system 30 may only require three mechanical unit pumps 40, each introducing fuel into common rail 70 twice per engine cycle. In this way, it is contemplated that for a given engine 12, the ratio of cylinders 18 to mechanical unit pumps 40 necessary for fuel system 14 may be equal to the number of lobes per cam 50 (i.e., the number of pumping cycles per complete rotation of cam 50).

Each mechanical unit pump 40 may be mechanically controlled to vary the amount of fuel delivered to fuel injection system 32 in any conventional manner known in the art. For example, each plunger 46 may include a scroll 56 that defines an effective stroke of plunger 46 based on a rotational position of plunger 46 and scroll 56. The effective stroke may define the amount of fuel that each mechanical unit pump 40 delivers to injection system 32 per stroke of plunger 46. For example, plunger 46 may be rotated in a first direction to allow for a longer effective stroke, increasing the amount of fuel delivered to injection system 32 for each stroke of plunger 46. Similarly, plunger 46 may be rotated in a second opposite direction to reduce the effective stroke, and thereby reduce the amount of fuel delivered to injection system 32. Each plunger 46 may include a gear or pinion 57 (shown only in FIG. 2) that interfaces with a rack 58. Linear movement of rack 58 may cause rotation of each plunger 46 via each gear 57. A motor 60 (referring to FIG. 1) may be configured to cause linear movement of rack 58, thus rotating plungers 46 until a desired effective stroke is achieved. In an exemplary embodiment, motor 60 may be a stepper motor capable of adjusting rack 58 by discrete amounts (i.e., rack settings), although other devices may be possible (e.g., hydraulic or pneumatic linear actuator).

In a conventional fuel system having mechanical unit pumps 40, the pressurized fuel from each individual mechanical unit pump 40 is delivered to a single passive mechanical injector for injection into one engine cylinder. For the purposes of this disclosure, a passive mechanical injector refers to an injection nozzle or other device that is not electronically controlled or actuated. In the disclosed fuel system 14, each mechanical unit pump 40 may be connected to deliver fuel to a plurality of fuel injection units 62 without significant modification to mechanical unit pumps 40.

In the exemplary embodiment of FIG. 1, each fuel injection unit 62 may be a retrofit part installed on an existing engine 12 to replace a conventional passive mechanical injector normally associated with a mechanical unit pump 40. Each fuel injection unit 62 may include an electronic control unit 64 and an injection nozzle 66 operable to inject an amount of pressurized fuel into combustion chamber 24. Each injection nozzle 66 may include a valve 68 that may be selectively closed to prevent fuel from being injected into a respective combustion chamber 24 and selectively opened for injection. Each valve 68 may normally be closed, but may be selectively opened by a corresponding control unit 64 such as, for example, based on a signal from control system 34, to inject fuel into combustion chambers 24.

Injection system 32 may also include a common rail 70 configured to store fuel pressurized by mechanical unit pumps 40 for fuel injection units 62. Common rail 70 may be installed on an existing engine to utilize existing conventional unit pumps (i.e., mechanical unit pumps 40). Common rail 70 may be connected to individual mechanical unit pumps 40 via independent supply conduits 72. In one embodiment, supply conduits 72 may be existing fuel conduits originally connecting mechanical unit pumps 40 to passive mechanical injectors (not shown). Common rail 70 may also be connected to each fuel injection unit 62 via discharge conduits 76. Discharge conduits 76 may be high-pressure conduits added as retrofit components that allow pressurized fuel from all mechanical unit pumps 40 to be shared between all fuel injection units 62. While common rail 70 is depicted as connecting all supply conduits 72 to all discharge conduits 76, it is contemplated that other arrangements may be possible. Individual rails may connect supply conduits 72 in sets of two, three, etc., such that fuel from some, but not all, of mechanical unit pumps 40 is shared with some, but not all of fuel injection units 62. For example, each of supply conduits 72 may be fluidly connected to exactly one other supply conduit 72 by a separate common rail 70.

As an additional retrofit component, one or more check valves 78 may be disposed in supply conduits 72, between mechanical unit pumps 40 and common rail 70, to help prevent reverse flow of fuel back to mechanical unit pumps 40 after introduction into common rail 70. Since fuel injection units 62 may be normally closed via valve 68 and fuel may be prevented from flowing back into pumping system 30 by check valves 78, fuel pressure may accumulate within common rail 70 as mechanical unit pumps 40 introduce fuel into supply conduits 72.

Control system 34 may include components configured to control various aspects of pumping system 30 and injection system 32. In an exemplary embodiment, control system 34 may include a controller 80 connected to a sensor 82 by a communication line 84. Controller 80 may also be electronically connected to motor 60 and each control unit 64 of fuel injection units 62 by communication lines 86 and 88, respectively. Controller 80 may be configured to receive a signal indicative of a performance parameter from sensor 82 via communication line 84, and responsively communicate with motor 60 and fuel injection units 62 via communication lines 86, 88.

Controller 80 may be an electronic control module (ECM) including one or more computing devices such as one or more microprocessors. For example, controller 80 may embody a general microprocessor capable of controlling numerous machine or engine functions. Controller 80 may also include all of the components required to run an application such as, for example, a computer-readable memory, a secondary storage device, and a processor, such as a central processing unit or any other means known. Various other known circuits may be associated with controller 80, including adjustment device and other appropriate circuitry.

Sensor 82 may be one or more pressure sensors configured to measure a fuel pressure and communicate the pressure reading to controller 80 via communication line 84. In an exemplary embodiment, sensor 82 may be positioned to measure a fuel pressure within common rail 70. Sensor 82 may be positioned anywhere within or near common rail 70 (e.g., supply conduits 72 and/or common rail lines 74) in which an average fuel pressure throughout common rail 70 may be determined. Controller 80 may be configured to interpret a signal from sensor 82 indicative of the pressure and determine if an adjustment to pumping system 30 and/or injection system 32 is necessary based on the signal.

### INDUSTRIAL APPLICABILITY

The disclosed fuel system 14 may be applicable to any new or existing engine system 10. In a new engine system, the disclosed fuel system 14 may be applicable as a common rail system that can be customized to include any number of mechanical pumps. In a retrofit application, the disclosed embodiments may be particularly applicable to adapting an existing engine system having conventional unit pumps into a common rail system without requiring replacement of the unit pumps. An exemplary process for retrofitting an existing engine to include fuel system 14 is described in more detail below, followed by a description of operation of fuel system 14.

In order to install a common rail system on an existing engine having mechanical unit pumps 40, each mechanical unit pump 40 may be disconnected from existing passive mechanical injectors. Each passive mechanical injector may be removed and replaced by electronically controlled fuel injection units 62. Next, an output of each mechanical unit pump 40 may be connected to fuel injection units 62. For example, supply conduits 72 may be connected together by common rail 70 and common rail 70 may be connected to each fuel injection unit 62 by a separate discharge conduit 76. It is contemplated that supply conduits 72, and/or discharge conduits 76 may be existing components or retrofit components, depending on the configuration of the existing engine. Check valves 78 may be installed in supply conduits 72 to prevent reverse flow of fuel into mechanical unit pumps 40.

In addition to the retrofit components described above, fuel system 14 may be modified to adjust a pumping strategy of pumping system 30. For example, cams 50 on pump driveshaft 52 may be modified or replaced to adjust the number of pumping cycles made by plungers 46 per revolution of cam 50. As shown in FIG. 2, an existing cam 50 having one lobe 90A may be replaced with a replacement cam 50 having two lobes 90A and 90B. This may be done for some or all of mechanical unit pumps 40, such that the number of mechanical unit pumps 40 required to fuel a given engine 12 may be reduced, as compared to an existing engine in which there is one mechanical unit pump 40 for each engine cylinder.

In addition, some or all of control system 34 may be installed to control the retrofitted pumping system 30 and injection system 32. Controller 80 may be installed on the existing engine and electronically connected to each fuel injection unit 62. Sensor 82 may be positioned to measure a fuel pressure in common rail 70 and electronically connected to controller 80. Controller 80 may also be electronically connected to motor 60 to create a pathway for adjustment of mechanical unit pumps 40. After installation, the existing engine may subsequently operate in conjunction with fuel system 14 to supply fuel to cylinder 18.

Referring to FIG. 1, when fuel system 14 is in operation, transfer pump 38 may supply fuel from fuel reservoir 36 to mechanical unit pumps 40. As engine 12 operates, each mechanical unit pump 40 may pressurize a separate supply conduit 72 with fuel. Mechanical unit pump 40 may supply fuel in any conventional manner known in the art. For example, rotation of cam 50 may cause each plunger 46 to reciprocate within a respective barrel 44 (e.g., move through pumping cycles consisting of an intake stroke and a pumping stroke). During the intake stroke of plunger 46, fluid may be drawn into barrel 44, above plunger 46. As plunger 46 begins the pumping stroke, increasing fluid pressure within barrel 44 may cause the fuel to enter supply conduit 72. Fuel may continue to enter supply conduit 72 until plunger 46 uncovers a spill port that allows fuel to enter spill passage 48 and flow back to fuel reservoir 36, which is at a lower pressure than supply conduit 72. The angular position of scroll 56 of plunger 46 may determine when the spill port is uncovered during each cycle. Therefore, the angular position of plunger 46 may at least partially determine the amount of fuel that enters supply conduit 72 per pumping cycle (i.e., effective stroke).

In a conventional mechanically controlled fuel system, the fuel that enters each supply conduit 72 may be immediately injected into a corresponding combustion chamber 24 through a passive mechanical injector. The disclosed engine 12 may originally include such a fuel system, and be retrofitted to include common rail 70, check valves 78, electronically controlled fuel injection units 62, and controller 80. In this way, the fuel that is pumped into supply conduits 72 may be stored in common rail 70 until fuel injection units 62 are selectively signaled to open valves 68 and allow fuel to be injected into combustion chambers 24. However, while fuel system 14 is described herein as a retrofit system, it should be understood that an engine may be originally constructed to include some or all of the components of fuel system 14.

In an exemplary process for controlling fuel system 14, controller 80 may adjust one or more components of fuel system 14 based on feedback from sensor 82 as operating conditions (e.g., engine load, speed, and/or lugging) of engine 12 change. Typically, an amount of fuel injected into combustion chambers 24 per engine cycle may increase as engine load increases, and vice versa. Therefore, the amount of fuel required to compensate for the decrease in fuel in common rail 70 may vary depending on operating conditions. It follows that a desired effective stroke of plunger 46 may also vary as engine conditions change (e.g., higher engine loads may generally require longer effective strokes than at higher engine loads).

Controller 80 may receive signals indicative of engine performance (e.g., engine speed, load, and/or lugging) and adjust the pumping system 30 and injection system 32 accordingly to change the amount of fuel provided to each cylinder 18. For example, if controller 80 determines that engine load is increasing, controller 80 may send a signal via communication lines 86 to instruct fuel injection units 62 to adjust the injection timing to open valve 68 for a longer period of time per injection. An adjustment in the amount of fuel injected may also be accomplished by increasing the fuel pressure in common rail 70, which is described in more detail below.

Sensor 82 may measure an average pressure in common rail 70 and send a signal indicative of the pressure to controller 80. Controller 80 may interpret the signal and determine if an adjustment to mechanical unit pumps 40 is necessary to achieve a desired fuel pressure within common rail 70. In an exemplary embodiment, the desired fuel pressure may correspond to an expected fuel pressure necessary to achieve a particular fuel injection amount (for a given fuel injection timing) to match one or more engine conditions. Further, if controller 80 determines that an actual pressure in common rail 70 is less than the desired pressure, controller 80 may adjust mechanical unit pumps 40 to increase the amount of fuel introduced into common rail 70 per pumping cycle, thereby increasing the fuel pressure in common rail 70. Similarly, a determination that the actual fuel pressure is greater than the desired pressure may result in an adjustment to reduce the amount of fuel delivered by mechanical unit pumps 40.

Motor 60 may facilitate adjustment of mechanical unit pumps 40 in a conventional manner. For example, controller 80 may send a signal via communication line 86 instructing motor 60 to move rack 58 and thereby cause plungers 46 to rotate within barrels 44 via gear 57. As has been described, rotation of plungers 46 changes the effective stroke of the associated mechanical unit pump 40. Therefore, controller 80 may control the amount of fuel introduced into common rail 70, and thus the fuel pressure, by sending signals to motor 60, which may adjust the effective stroke of one or more of mechanical unit pumps 40 accordingly. Controller 80 may follow a control map to determine the degree of adjustment of rack 58 necessary to match an actual fuel pressure in common rail 70 to a desired fuel pressure. In this way, fuel system 14 may utilize control system 34 to control pumping system 30 and injection system 32 to allow engine 12 to operate efficiently.

The fuel system 14 of the present disclosure may have application in various engine systems, especially in those including mechanical unit pumps, by allowing engines to be adapted to include a common rail fuel system while maintaining use of some existing fuel system components. This is accomplished by adding check valves 78 and common rail line 70 to allow fuel pressure to accumulate in supply conduits 72 while preventing over-pressure on any one fuel injection unit 62. Further, since the creation of common rail 70 shares fuel pressure among all fuel injection units 62, improved consistency of fuel injection across cylinders 18 and greater control of fuel injection is achieved. Greater control of fuel injection in a retrofitted engine 12 may produce improved engine performance, since control of parameters such as engine speed, load, and lugging may be controlled more directly by inputs to fuel injection units 62 (as opposed to indirectly via adjustment of mechanical unit pumps 40). In addition, the inclusion of controller 80 and sensor 82 completes a conversion to an electronically controlled common rail system while allowing mechanical unit pumps 40 to be kept in place, which may help avoid costly purchase of a new pump.

An additional advantage may be achieved by modifying the shape of cams 50 (e.g., to include two lobes 90A, 90B as shown in FIG. 2) to result in fewer mechanical unit pumps being necessary to supply common rail 70. This may produce cost savings in a new engine application, since fewer pumps will need to be included. In a retrofit engine application, additional advantages may be gained since pumps may be removed and utilized for other purposes (e.g., as replacement parts) or remain in place as backup pumps.

It will be apparent to those skilled in the art that various modifications and variations can be made to the fuel system of the present disclosure without departing from the scope of the disclosure. Other embodiments will be apparent to those skilled in the art from consideration of the specification and practice of the embodiments disclosed herein. It is intended that the specification and examples be considered as exemplary only, with a true scope of the disclosure being indicated by the following claims.

What is claimed is:

1. A fuel system for an engine having a crankshaft and a plurality of cylinders, the fuel system comprising:
a plurality of plungers separately connectable to the crankshaft;
a plurality of fuel injectors associated with the plurality of cylinders;
a common rail configured to store pressurized fuel;
a plurality of first conduits, each first conduit fluidly connecting a barrel associated with a respective one of the plurality of plungers to the common rail; and
a plurality of second conduits, each second conduit fluidly connecting the common rail to a respective one of the plurality of fuel injectors.

2. The fuel system of claim 1, wherein a rotational position of each of the plurality of plungers determines an amount of fuel introduced into a respective one of the plurality of first conduits per stroke.

3. The fuel system of claim 2, further including a motor configured to adjust the rotational position of the plurality of plungers.

4. The fuel system of claim 3, further including a rack operably connecting the motor to the plurality of plungers.

5. The fuel system of claim 3, further including:
a sensor configured to generate a signal indicative of a fuel pressure in the common rail; and
a controller in communication with the motor and the sensor, the controller configured to selectively adjust the rotational position of the plurality of plungers based on the signal.

6. The fuel system of claim 1, wherein each of the plurality of first conduits is fluidly connected to each of the others of the plurality of first conduits by the common rail.

7. The fuel system of claim 1, wherein each of the plurality of first conduits is fluidly connected to one other of the plurality of first conduits by a separate common rail.

8. The fuel system of claim 1, wherein:
each of the plurality of plungers is operatively connectable to the crankshaft by a cam having at least one lobe; and
the ratio of the number of the plurality of cylinders to the number of the plurality of plungers is equal to the number of the at least one lobe per cam.

9. The fuel system of claim 8, wherein the at least one lobe includes two lobes.

10. The fuel system of claim 1, further including a check valve in each of the plurality of first conduits.

11. A method of retrofitting an existing engine having a plurality of mechanical unit pumps and a plurality of cylinders, comprising:
fluidly disconnecting each of the mechanical unit pumps from an existing passive mechanical injector;
fluidly connecting an output of each of the plurality of mechanical unit pumps together by a common rail;
installing a plurality of electronically controlled fuel injectors; and
fluidly connecting the common rail to each of the plurality of electronically controlled fuel injectors.

12. The method of claim 11, wherein connecting an output of each of the plurality of mechanical unit pumps together includes connecting a plurality of supply conduits together by the common rail.

13. The method of claim 12, further including installing a check valve in each of the plurality of supply conduits.

14. The method of claim 11, wherein the number of the plurality of mechanical unit pumps is equal to the number of the plurality of engine cylinders.

15. The method of claim 11, further including operably connecting each of the plurality of mechanical unit pumps to a crankshaft of the engine by a cam.

16. The method of claim 15, wherein a ratio of the number of the plurality of cylinders to the number of the plurality of mechanical unit pumps is equal to the number of pumping cycles per complete rotation of the cam.

17. The method of claim 15, wherein:
operably connecting each of the plurality of mechanical unit pumps to a crankshaft of the engine by a cam includes removing an existing cam and installing a replacement cam, and
the replacement cam has a different number of lobes than the existing cam.

18. The method of claim 11, further including electronically connecting a controller to each of the plurality of electronically controlled fuel injectors.

19. The method of claim 18, further including electronically connecting the controller to a pressure sensor in the common rail and a motor operably connected to the mechanical unit pumps.

20. An engine, comprising:
an engine block defining a plurality of cylinders;
a piston disposed within each of the plurality of cylinders;
a crankshaft operably connected to the piston; and
a plurality of plungers separately connectable to the crankshaft;
a plurality of electronically controlled fuel injectors associated with the plurality of cylinders;
a common rail configured to store pressurized fuel;
a plurality of first conduits, each fluidly connecting a barrel associated with a respective one of the plurality of plungers to the common rail; and
a plurality of second conduits, each fluidly connecting the common rail to a respective one of the plurality of electronically controlled fuel injectors.
